(19) United States
(12) Patent Application Publication
(10) Pub. No.: US 2020/0064194 A1
(43) Pub. Date: Feb. 27, 2020

(54) VEHICLE COLOR MEASUREMENT METHODS AND DEVICES

(71) Applicant: X-Rite Switzerland GmbH, Regensdorf (CH)

(72) Inventors: Christophe DAUGA, Regensdorf (DE); Thomas NETTER, Regensdorf (CH); James William VOGH, Boxford, MA (US); Peter EHBETS, Regensdorf (CH)

(21) Appl. No.: 16/609,693

(22) PCT Filed: May 3, 2018
(86) PCT No.: PCT/US2018/030884

§ 371 Date: Oct. 30, 2019

Related U.S. Application Data
(60) Provisional application No. 62/501,036, filed on May 3, 2017.
(60) Provisional application No. 62/501,434, filed on May 4, 2017.

(51) Int. Cl. G01J 3/50; G01J 3/02

(52) U.S. Cl. CPC G01J 3/501; G01J 3/0208; G01J 3/504; G01J 3/0272; G01J 3/0289

(57) ABSTRACT

A mobile device for measuring reflectance properties of a surface includes a first imaging device comprising an image sensor and a lens characterized by an optical axis; a first illumination source having an optical axis disposed at an angle of 45° with respect to the first imaging device lens' optical axis; a second imaging device comprising an image sensor and a lens characterized by an optical axis; and a second illumination source having an optical axis intersecting the first imaging device lens' optical axis where the first illumination source intersects the first imaging device lens' optical axis, the optical axes of the first imaging device and the second illumination source defining a second measurement plane. The mobile device further comprises a computer processor and a non-volatile memory comprising computer-readable instructions to acquire data from the first and second imaging devices and derive reflectance information of the surface of interest.

### RELATED APPLICATIONS

This application is a national phase application of and claims the benefit of International Application PCT/US2018/030884, filed May 3, 2018, and further claims the priority benefit of, U.S. Ser. No. 62/501,036, filed May 3, 2017, and U.S. Ser. No. 62/501,434, filed May 4, 2017.

### BACKGROUND

The field of the invention concerns matching automotive paints and/or coatings for making repairs to damaged vehicles. The paint color of an automobile often has a corresponding color code which defines the appearance of the paint as originally applied. For example, BMW paint code A76 is a metallic paint with the name “Deep Sea Blue.” Paint codes are often marked on body panels of an automobile. Additionally, paint chips may be included in an owner's manual for a vehicle.

Even with such paint code information, producing a new paint having a good match with existing paint for repair purposes without accurately measuring the appearance of the paint to be matched is difficult for several reasons. First, the paints corresponding to the same paint code may have been prepared by different manufacturers, applied in different factories, and across several years of production runs. Thus, any one individual vehicle, for example an automobile, will experience some variation from the original target color. Second, paints and coatings may be exposed to harsh environmental conditions for many years, and may experience fading or other environmental damage. Third, different components on any one automobile may have different paints or coatings. For example, steel body stampings may have been painted in one paint shop, and plastic or composite molded components (such as flexible bumper covers) may have been painted in a different paint shop with a different coating. Finally, the automobile in question may have already been the subject of a prior repair or re-painting.

In view of the foregoing, it is common for an automotive repair shop to make multiple measurements of the reflectance properties of paint on a vehicle, for example an automobile, at undamaged locations close to damaged locations to characterize the existing surface to assist in formulating a good match for the surface to be repaired. A multi-angle spectrophotometer may be used for these measurements. Multi-angle spectrophotometers are useful to characterize surface appearances from various lighting angles and observation angles. Also, the repair shop typically makes an estimate of the surface area to be repainted to serve to calculate an estimate of the amount of paint to be prepared. The repair shop then searches for the nearest color match in one or more databases, based on car make, model, color code, year, and colorimetry measurements. When the color is matched, a recipe is obtained, the recipe comprising the weights of various paint components to be mixed. The components may then be measured by weight, combined, and applied to a surface of one or more repaired surfaces or repair components. When painting a damaged area, some over-blending of undamaged areas is typically included to reduce the visibility of color or appearance mismatches. A visual assessment of the repair is made to determine whether the paint was successfully matched.

There are several disadvantages to the current workflow described above. For example, the amount of data to be searched in one or more databases for this workflow, given that all color variants for different automotive manufacturers may span years or decades of different automotive finishes, may be enormous. Also, the paint components corresponding to the recipes in the database must be kept in stock so that the painted end result is as near as possible to desired result. Batch-to-batch variations between recipe components need to be reduced or accounted for to enable a good match from the recipe. Even with the correct recipe and paint components called for by the recipe, the end result will depend in part on the skill used to measure and blend the components, which may result in deviations from the target color. Sometimes paints must be mixed multiple times or different recipes selected before a good match can be achieved.

### SUMMARY

A mobile device 6000 may be adapted for measuring reflectance properties of a surface of interest by including on the mobile device a first imaging device 6015 comprising an image sensor 6011 and a lens 6010 characterized by an optical axis; a first illumination source 6057 having an optical axis intersecting the first imaging device lens' optical axis at an angle of 45°, the optical axes of the first imaging device and the first illumination source defining a first measurement plane; a second imaging device 6025, spaced from the first imaging device 6015, comprising an image sensor 6021 and a lens 6020 characterized by an optical axis; and a second illumination source 6051, 6052, 6053, 6054, 6055, 6058, 6251, 6253 having an optical axis intersecting the first imaging device lens' optical axis where the first illumination source 6057 intersects the first imaging device 6015 lens' optical axis, the optical axes of the first imaging device 6015 and the second illumination source 6051, 6052, 6053, 6054, 6055, 6058, 6251, 6253 defining a second measurement plane. The mobile device may further comprise a computer processor 6090 and a non-volatile memory 6095 comprising computer-readable instructions to acquire data from the first and second imaging devices and derive reflectance information of the surface of interest. Reflectance information may comprise visible color reflectance information. The mobile device may be configured to acquire image data from the first and second imaging devices simultaneously.

The optical axes of the first imaging device and the first illumination source may define a first measurement plane, and optical axes of the second imaging device and the second illumination source may define a second measurement plane. The first and second measurement planes may be in the same plane. The first and second measurement planes may be in different planes. For example, the first and second measurement planes may be parallel, intersecting, or orthogonal to each other.

The first illumination source may be located such that first illumination source's optical axis is disposed also at an angle of 45° to the second imaging device's optical axis. Alternatively, the first illumination source may be located such that first illumination source's optical axis is not disposed at an angle of 45° to the second imaging device's optical axis. The mobile device may be configured to acquire image data from the first and second image sensors corresponding to 45° and non-45° measurement paths 6551, 6552 simultaneously.

The mobile device may be configured such that a first field of view corresponding to the first imaging device and a second field of view corresponding to the second imaging device overlap, and the mobile device may configured to process images of the overlapping fields of view to provide a stereoscopic image of the surface of interest, surface texture information for the surface of interest, effect pigment information for the surface of interest, or any combination thereof.

The first and second imaging devices may comprise RGB image sensors. The first and second illumination sources comprise broadband white light LEDs. The mobile device may further comprise a plurality of LEDs located to provide different measurement paths 6551, 6552 to the first and second imaging devices, the plurality of LEDs selected to emit one or more of red (620-750 nm), green (495-570 nm), blue (450-495 nm), violet (380-450 nm), infrared (700 nm-1 mm) or ultraviolet (10-400 nm) wavelengths. The first and second illumination sources may be part of a plurality of illumination sources disposed to provide a plurality of measurement angles with respect to the first and second imaging devices.

The first and second illumination sources may be mounted on a lighting accessory attached to the measurement device. In this example, the lighting accessory may include a controller 6090 to command, control, or regulate the illumination of the first and second illumination sources independently of each other. In some embodiments, for example on a mobile device, for example a mobile phone, the first and second illumination sources may be controlled independently of each other by one or more of the mobile device's processors.

In another example, at least one of the first and second imaging devices in the mobile device may comprise a Fourier lens and an optical image sensor.

In another example, a mobile device adapted for measuring reflectance properties of a surface of interest may include a first imaging device 6015; a first illumination source spaced from the first imaging device to provide a first 45° measurement path 6551 when the mobile device is located at a target distance 6065 from the surface of interest, the first 45° measurement path comprising a first illumination path and a first measurement path defining a first measurement plane; a second imaging device spaced from the first imaging device; a second illumination source spaced from the second imaging device to provide a second 45° measurement path when the mobile device is located at the target distance from the surface of interest, the second 45° measurement path comprising a second illumination path and a second measurement path defining a second measurement plane. The first illumination source is also spaced from the second imaging device to provide a third measurement path when the mobile device is located at the target distance from the surface of interest, the third measurement path comprising a third illumination path and a third measurement path defining a third measurement plane; and the second illumination source is also spaced from the first imaging device to provide a fourth measurement path when the mobile device is located at the target distance from the surface of interest, the fourth measurement path comprising a fourth illumination path and a fourth measurement path defining a fourth measurement plane. The mobile device is configured to process image data acquired from the first and second imaging devices to derive reflectance information of the surface of interest.

In one example, the first, second, third and fourth measurement planes are in the same plane. In another example, the first and second measurement planes are parallel to each other, and the third and fourth measurement planes intersect. In another example, the third and fourth measurement paths comprise 45° measurement paths outside of the first measurement plane. In another example, the third and fourth measurement paths comprise non-45° measurement paths within the first measurement plane.

### BRIEF DESCRIPTION OF THE DRAWINGS

FIG. 1 is a flow chart of a color/appearance measurement process according to one aspect of the present invention.

FIGS. 2A and 2B illustrate a Color Calibration Card which may be used in connection with a color/appearance measurement process according to another aspect of the present invention.

FIGS. 3A and 3B illustrate a Color Calibration Card which may be used in connection with a color/appearance measurement process according to another aspect of the present invention.

FIG. 4 is a flow chart of another color/appearance measurement process according to another aspect of the present invention.

FIG. 5 is a flow chart of another color/appearance measurement process according to another aspect of the present invention.

FIGS. 6A and 6C illustrate mobile devices with a plurality of imaging devices and illumination sensors according to another aspect of the present invention.

FIGS. 6B, 6D and 6E illustrate measurement geometries for mobile devices according to FIGS. 6A and 6C according to various aspects of the present invention.

FIG. 7 illustrates a Fourier lens geometry which may be used in combination with a mobile device according to the present invention.

FIGS. 8A, 8B and 9 illustrate various aspects of a vehicle color/appearance measurement system according to another aspect of the present invention.

### DESCRIPTION

Several related concepts are described herein which reduce or eliminate the known disadvantages of the prior art. These concepts may be used independently or in combination with each other.

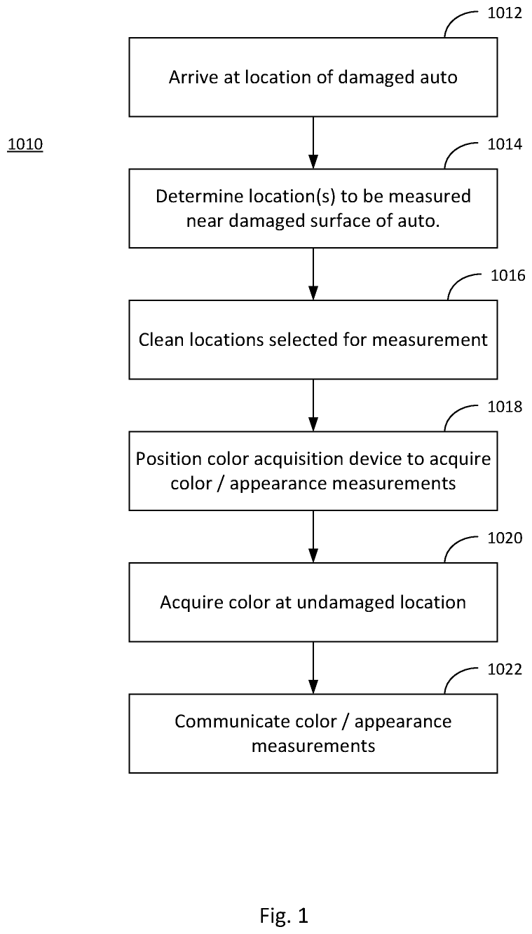

The time to prepare suitable paints or coatings may be reduced by making measurements before a damaged auto arrives at a repair shop, and then communicating those measurements to one or more persons responsible for paint formulations. This may be done at the scene of an accident or an accident investigation site to which damaged cars may be move to after an accident. An exemplary coating measurement process 1010 is illustrated in FIG. 1. The steps involve arriving at the location of the damaged automobile 1012, determining one or more location(s) to be measured near a damaged surface of the auto 1014, and cleaning the selected locations where color/appearance measurements will be acquired 1016. Typically, these points would be at undamaged locations that are nearest the damaged locations, for example within 1 m to 10 cm, or within 30 cm to 10 cm of damage location.

In steps 1018 and 1020, a person may then position a color acquisition device to acquire color/appearance measurement of the selected one or more points on vehicle. The color/appearance measurements may then be communicated to a body shop or factory/distributor, for example using wireless communication features of color acquisition device in step 1022. The communication may also include the measured vehicle's make, model, year, and paint color code. Optionally, raw acquisition measurements may also be included in the communication.

When taking measurements at the scene of an accident as described above, or in other situations, a spectrophotometer may not be available. Typical consumer hand-held devices, for example mobile devices comprising photographic and communication devices, for example smartphones, digital cameras, or tablet computers, may not have sufficient calibration, lighting control, or color gamut to properly measure the color and surface appearance characteristics of automotive finishes.

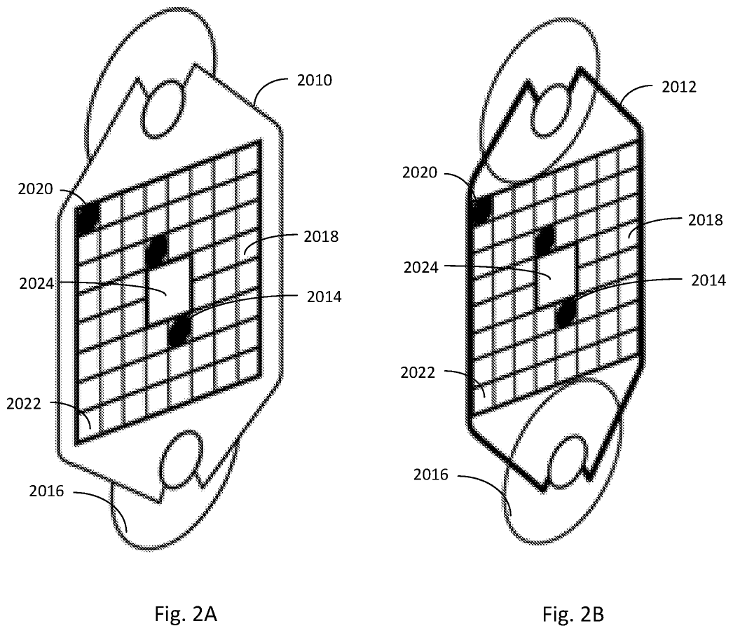

A mobile device may be provided comprising a color camera. The mobile device may comprise, for example, a mobile phone, a mobile phone comprising multiple light sources, a tablet computer, a mobile device with a separate plugin camera accessory, a mobile device with separate plugin light accessories, or a mobile device with a plugin camera accessory with lights, or any combination thereof. “Color camera,” as used herein, refers to a multi-spectral imaging device, such as an RGB camera. While a typical color camera has a minimum of 3 different channels (e.g. RGB), additional channels may be included. To improve accuracy, a Color Calibration Card may also be included. Examples of Color Calibration Cards are illustrated in FIGS. 2A and 2B. FIG. 2A is an illustration of a Color Calibration Card 2010 having an opaque substrate. FIG. 2B is an illustration of a Color Calibration Card 2012 having a transparent or translucent substrate.

A Color Calibration Card may comprise one or more of, non-planar target elements 2014, support means 2016, reference paint patches 2018, and color patches 2020. Non-planar target elements 2014 for estimation of light direction may comprise a partially spherical element or a multi-planar element having surfaces that are not parallel to the substrate of the Color Calibration Cards 2010, 2012. See, for example, U.S. Pat. Pub. No. 2016/0224861, which is incorporated by reference. Support means may be provided to maintain the calibration card on vehicle. For example, adhesive tape (not illustrated), one or more suction cups 2016 (which may also be used on wet surfaces), and/or magnets (not illustrated) may be included to attach the Color Calibration Cards 2010, 2012 to the surface to be measured. Support means may also include a deformable structure (for example, made of metal) to enable a user to apply a measurement window or opening frame, for example a color card's measurement window, against the surface to be measured. Standard vehicle paint color patches 2018 may be provided as reference colors. Color patches 2020 comprising calibration color sets may be included. Also, texture patches 2022 for effect pigments and finishes (e.g. of different light to dark flop levels and of different coarseness levels) may be included. Finally, a measurement window 2024 may be provided, through which the surface to be measured is visible. Different color filters may also be included in the measurement window. See, for example, U.S. Pat. Pub. No. 2016/035665, which is incorporated by reference.

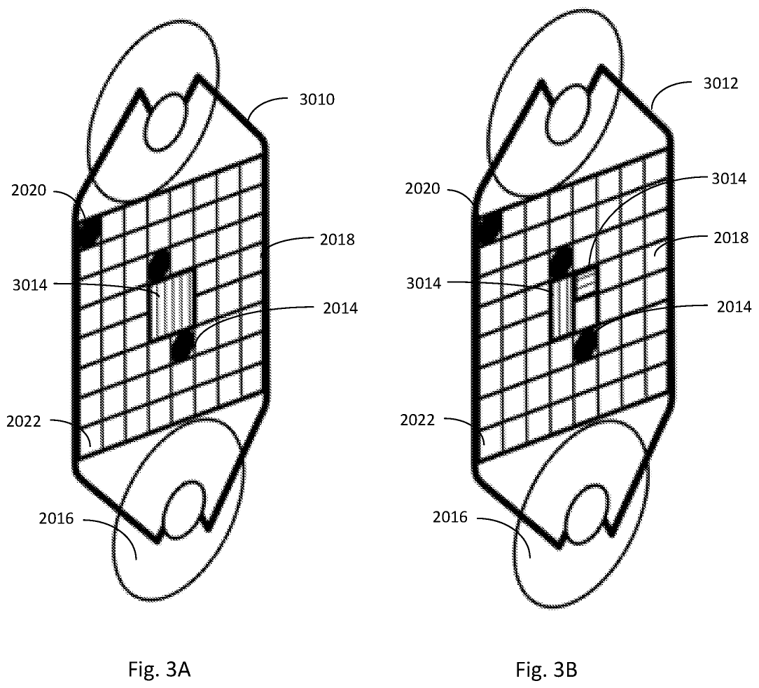

Referring to FIGS. 3A and 3B, Color Calibration Cards 3010, 3012 may also comprise one or more louvered plastic films 3014. For example, one or more louvered plastic films may be comprised in all or a portion of the measurement area or window 2022. The louvered plastic films limit the viewing angles of light being reflected from one or more areas being measured. This may be desirable when a multi-angle spectrophotometer or camera with multiple light sources is not available, but the pigments or finishes to be measured have different appearances at different viewing angles.

For example, Color Calibration Card 3010 may include a single film 3014 covering a portion of the measurement area 2022. In the example of FIG. 3A, a single film 3014 covers all of measurement area 2022. A Color Calibration Card may also include two or more films 3014 with different orientations placed adjacent to each other and together covering a portion of or all of the measurement area 2022, as shown in FIG. 3B. Two or more films may also be arranged with different orientations, with one or more overlapping portions. Orientations may include, but not limited to:

a) For 2 filters: for example: 0° and 90°; 0° and 45°; or 0° and 15°.

b) For 3 filters: for example: 0°, 45°, 90°; 0°, 15°, 45°; or 0°, 30°, 60°.

Color Calibration Cards as described herein may also include one or more louvered plastic films as described herein further comprising one or more 2-dimensional arches or 3-dimensional dome portions. For example, a single 2D arch may comprise radius from about 2 mm to 3 cm. Sheet portions, with louvers oriented 90°, forming two 2D arches, may be joined to form a pyramidal dome.

Color Calibration Cards as described herein may further include one or more microlens array domes in the measurement area 2022. For example, a plurality of lenses may be set at 90° with respect to a measured plane, and in 15° increments in elevation in X and Y directions and 15° in azimuth direction.

Advantageously, if a paint chip has been delivered with the vehicle's owner's manual, the paint chip may be used in combination with the methods and devices described, herein. The paint chip may have been painted at time of vehicle's production or selected from a fandeck reproduction of the vehicle color standard. The paint chip may be used to calibrate the measuring device prior to acquisition at point of accident. The paint chip can be for example used to measure the difference between the vehicle's color at one or more locations and the chip.

The paint chip may comprise a bar code, QR code, or other scannable encoded data providing one or more of: a Paint ID; a Paint color specification, e.g. CIE LAB data over multiple angles; Recipe specifications indicating coarseness level; and Vehicle ID. The reverse side of the paint chip may further comprise a reference white patch usable for calibration of a color measurement device and/or one or more reference patches comprising effect pigments usable for calibration of a color measurement device.

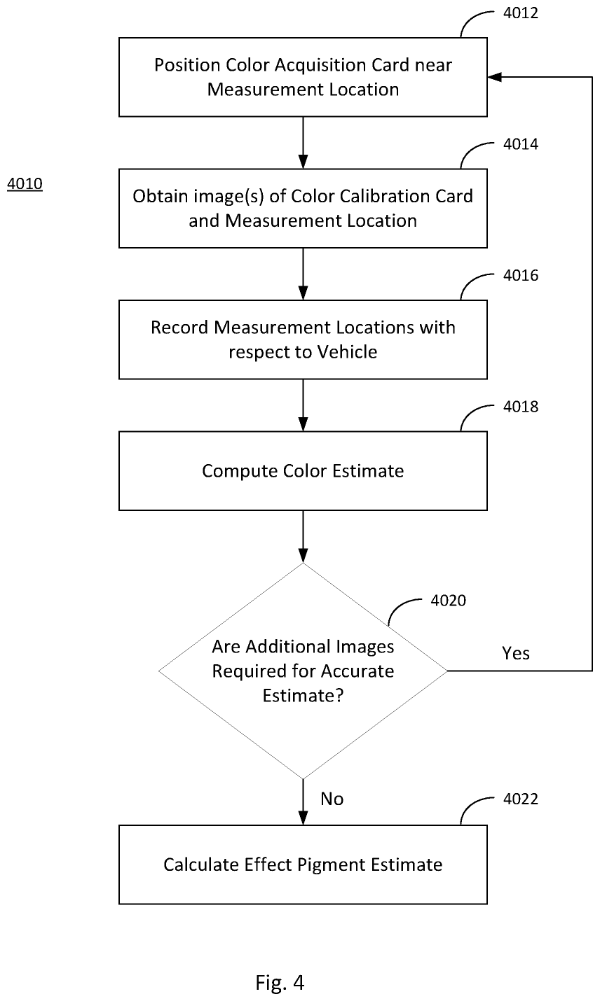

All of the devices and Color Calibration Cards as described above may be used as according to an example of a measurement process 4010, as illustrated in FIG. 4. In step 4012, a user positions a Color Calibration Card at a location to acquire a desired color measurement. In step 4014, one or more images of the Color Calibration Card and measurement location is acquired.

Optionally, in step 4016 location of the mobile device with respect to where measurement is taken with respect to the vehicle may be recorded with the measurements, for example using one or more of: spoken voice (optionally with speech recognition); typing; selecting the part on a vehicle diagram, for example displayed on the mobile device; moving back from the vehicle and aiming the mobile device's camera, for example the camera's sight, at the measurement location, an image recognition method then detects the vehicle part and returns a metric with respect to the vehicle or part. The mobile device's display may include graphical means to define the zone to repaint, for example by drawing using finger on the device's touchscreen or by adjusting markers or sliders. The geographic location of usual parking, geographic location of place where measurement is made, geographic orientation of the camera, time of day, or ambient light measurements may also be recorded with the measurements.

Once the measurements have been taken, a color or appearance estimate may be computed in step 4018. If additional measurements are required to obtain an accurate estimate in step 4020, the process may be directed to step 4012 to acquire additional images. The color estimate may be computed by one or more of the mobile device's embedded computer system or a separate computer system. The separate computer system may be in real-time communication with the mobile device to receive measurement data from the mobile device and return color or appearance estimates to the mobile device.

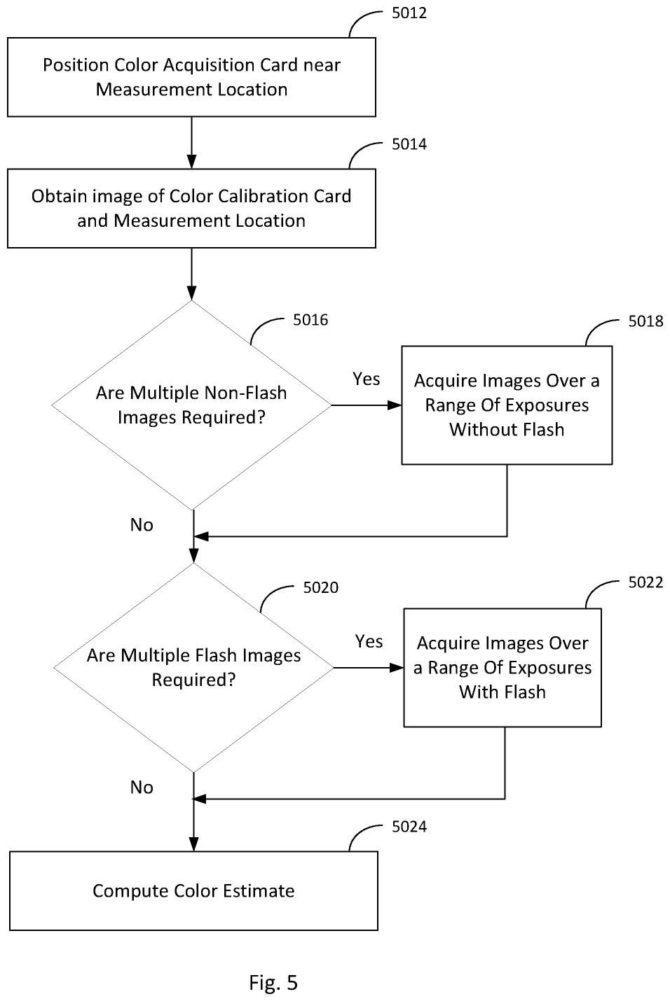

In another example, as illustrated in FIG. 5, a process 5010 for obtaining multiple images of the measurement location with the mobile device is provided. In step 5012, a user positions the Color Calibration Card at a location to acquire a desired color measurement. An image of the Color Calibration Card and measurement location is acquired in step 5014. In step 5016, a decision is made as to whether multiple non-flash images are required. If affirmative, in step 5018, multiple images are acquired of the measurement location and Color Calibration Card without flash over a range of exposures. In step 5020, a decision is made as to whether multiple flash images are required. If affirmative, in step 5022, multiple images are acquired of the measurement location and Color Calibration Card with flash illumination are acquired at different exposures. Both flash and non-flash images may be taken of the measurement location and Color Calibration Card. A color estimate is then computed in step 5024 based on the acquired images.

Paint on vehicle parts does not age in the same way or at the same speed depending on the position on the vehicle, where the vehicle is parked (indoors or outdoors), or the geographic location or environment where it is mostly used. The color estimator method may comprise an aging model. The aging model may use information about the one or more locations on the where the measurements have been acquired. The aging model may for example use information about one or more of the vehicle's model, year of manufacturing, color reference or code, vehicle part, orientation of the vehicle part with respect to horizontal, geographic location of usual parking, geographic location of place where measurement is made, geographic orientation of the camera, time of day, ambient light measurements, or known recipe components. The aging model may be used by the color estimator method to provide a measurement confidence level, possibly requesting that additional measurements be taken at location or at other locations, for example locations within 30 cm or 50 cm radius. The aging model may also be used to recommend measurements at an opposite side of the vehicle or other parts to elaborate a more complete evaluation of the vehicle's paint condition. The aging model may also be used to correct some measurements, for example using aging model information or one or more other measurements taken on the vehicle or other vehicles, for example a fleet of vehicles.

Once the color estimate is prepared, the next step 4022 may be to compute an effect pigment estimate. One step for estimating the amount and type of effect pigments comprised in the paint layer may be to compare the texture scale of the sampled measurement location to known texture scales on Color Calibration Card texture patches 2022. The computation may match measured texture to texture scales stored in database comprising measurements, simulated measurements, or simulated renderings of effect pigment layers. The texture scales stored in the database may comprise objective coarseness measurements. The texture scales stored in the database may comprise perceived coarseness measurements (e.g. from testing using human observers). The database or database search method may comprise conversion functions to convert objective coarseness measurements to perceived coarseness measurements.

The method may comprise entering a vehicle identification number, for example a number that may be found on the vehicle's chassis, into the device, for example by scanning a QR code in the vehicle's owner's manual, scanning a bar or QR code found on the chassis, manually typing the vehicle identification number, or speaking the vehicle identification number to device or a natural language recognition system operating with or within the device.

The mobile device may contact a vehicle database and retrieve and compare measured colors to color codes from the vehicle database. If available, the mobile device may also retrieve vehicle build date(s) and/or sale(s) dates to determine an actual age of the paint/coating to be matched. The mobile device may display a rendering of the vehicle, for example highlighting locations of expected paint aging and/or to guide operator to acquire measurements from additional measurement locations.

The mobile device may be programmed to use the color estimates to propose formulation recipes on the fly at the time paint measurements are acquired. The formulation recipes may be generated by the mobile device or by a remote server in communication with the mobile device. The formulation recipes may be adjusted as the number of paint measurements is increased and the confidence on aging estimates improves. The mobile device may display (or speak) the formulation recipe to paint, for example to spray, and parameters useful for the operator responsible for repainting all or portions of the vehicle for example one or more of: LE, for example calculated on CIE76, CIE94, or CIEDE2000. The parameters useful for the operator may be simulated or estimated prior to the painting operation or be measured after painting, for example one or more of: ΔE, for example calculated on CIE76, CIE94, or CIEDE2000; lightness ΔL, chroma ΔC, or hue ΔH; spectrum comparison metrics, for example based on spectrum shape, spectrum shape differences, derivatives or gradients over spectrum segments, histogram-based comparisons; sharpness or haze, for example sharpness of reflection of a light source or structured light source at one or more angles, for example at one or more of 15°, 45°, 60°, 75°, or close to 90°, within a 5° margin, from surface normal or measurement optical axis; waviness, measured for example by reflecting a light source or structured light source at one or more angles, for example at one or more of 15°, 45°, 60°, 75°, or close to 90°, within a 5° margin, from surface normal or measurement optical axis.

The methods and devices described above may also be combined with a multi-angle, multi-image acquisition method. In this method, after a Color Calibration Card is placed at a desired measurement location, the user positions the mobile device (or other acquisition device) to face the location to acquire so that camera's optical axis is approximately aligned with color card's sample window's normal (i.e., perpendicular).

A user may then aim the mobile device at a first orientation opposite that of a source of ambient light (a source of ambient light may for example be the Sun, the sky, or ceiling lighting), for example below damage point with tilt up but no pan angle. For a third angle, the user may aim the mobile device at a second orientation opposite ambient light, for example right of the damage point with a pan left but no tilt angle.

As with the methods described above, images may be taken to acquire a measurement location and a Color Calibration Card without flash over a range of exposures, with flash over a range of exposures, or a combination of flash and non-flash exposures.

In addition to, or in lieu of, the multi-angle still images described herein, video images acquired during motion between and at different measurement angles may also be recorded and analyzed. For example, a user may perform one or more left-to-right or right-to-left movements while aiming the mobile device (or camera) towards the measurement location and Color Calibration Card, and then return to normal alignment. A user may also perform one or more up/down movements while aiming the mobile device towards the measurement location and Color Calibration Card, and then return to normal alignment. Because video images may include some blurring and have a lower resolution because of spatial and temporal digital compression algorithms, image enhancement methods that combine overlapping images may be used, for example super-resolution imaging methods. A graphical or auditory interface on the device may inform the operator of the acquisition's quality and may, for example, guide the operator towards repeating acquisitions at some locations. The steps of computing the color estimate and effect pigment estimate (e.g. recipe to spray) are computed as described above.

The method may be associated with a production line method that generates a digital signature of the vehicle's paint at production time. The production line method may for example use a color or appearance measuring device, for example a multi-angle spectrophotometer, held by a robotic arm to acquire color or appearance measurements at key locations on the vehicle. The data acquired by the color or appearance measuring device may then be used by paint shops to increase their measurements' confidence level. The color or appearance measurement data acquired by a paint shop may be sent back aging to the vehicle manufacturer, for example to increase the data in a color and appearance database or to refine paint aging models.

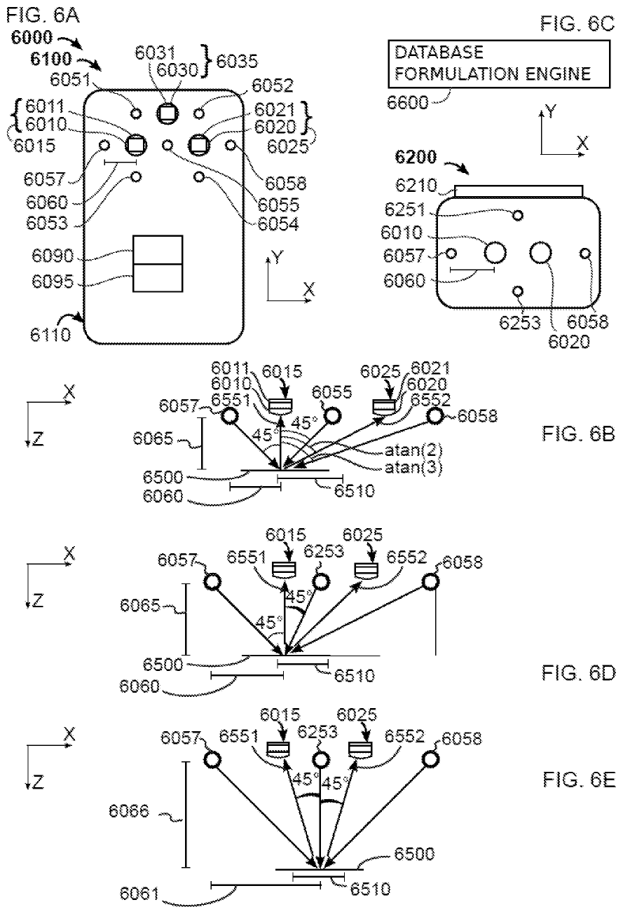

FIG. 6A presents a lighting accessory for mobile devices 6100 comprising a ring of illumination sources such as LED's (6051, 6055, 6053, 6057) or (6052, 6058, 6054, 6055) or (6051, 6052, 6058, 6054, 6053, 6057) is also provided herein. The lighting accessory 6100 may be formed of a shell that fits onto a mobile device, for example the so-called back side of a mobile phone 6000. The mobile phone may comprise a display 6110. The lighting accessory may be the actual back side of the mobile device. The lighting accessory may comprise one or more electrical connectors, for example power or data connectors. The lighting accessory may be an electronic assembly, for example without a shell component or a casing component. The lighting accessory may be comprised in a mobile device, for example a mobile phone 6000. The LED's may comprise white LED's and may provide different illumination angles shown in FIG. 6B to a measurement location 6500 and a Color Calibration Card. The LED's may comprise one or more color LED's, for example selected to emit one or more of red (620-750 nm), green (495-570 nm), blue (450-495 nm), violet (380-450 nm), infrared (700 nm-1 mm) or ultraviolet (10-400 nm) wavelengths. One or more LED's may be capable of illuminating alternatively or in combination with two or more wavelengths. The LED Ring may be fitted around the one or more lenses 6010, 6020 of a mobile device. The mobile device 6000 or lighting accessory 6100 may comprise two or more imaging devices, for example image sensors 6011, 6022. For example, a first image sensor 6011 and a first lens 6010 may be comprised in a first imaging assembly 6015. For example, a second image sensor 6021 and a second lens 6020 may be comprised in a second imaging assembly 6025. The LED Ring need not necessarily be circular shaped, and other geometries may be preferable for various incident lighting angles.

The image sensors may have one or more of area and resolution that are different from each other. For example, the second image sensor may have the same area as the first image sensor but a different resolution, for example half the resolution in one or more directions of the image plane. For example, each pixel of the second image sensor may have four times the area of each pixel in the first image sensor. In some embodiments, the second image sensor may be exposed or sampled for a longer time period than the first image sensor. In some embodiments, the image acquired by the second image sensor may be characterized by a having a greater exposure than the image acquired by the first image sensor. In some embodiments, one or more of the image sensors may be configured to acquire a plurality of images within a burst, for example three images per image sensor, at a plurality of exposure settings, for example at a plurality of exposure durations. The plurality of images acquired within a burst by a given image sensor may be acquired sequentially, for example, within less than 1 second. The plurality of images acquired within a burst may be combined to form a high dynamic range (HDR) image.

In some embodiments, the optical axis of the first imaging device 6015 and the optical axis of the second imaging device 6025 may be parallel. In other embodiments, the optical axis of the first imaging device 6015 and the optical axis of the second imaging device 6025 may be convergent, for example at angle comprised in a range between 0° and 15°, for example between 2 and 3°. The second imaging device 6025 may be spaced from the first imaging device so that the lens 6020 or the lens' 6020 optical center of the second imaging device is within the specular reflection of the first illumination source 6057 when the first imaging device 6015 is at a target distance 6065 from a measurement location 6500. Conversely, the first illumination source 6057 may be positioned on the lighting accessory for mobile devices 6100 so that it illuminates the measurement location 6500 with a collimated beam that intercepts the optical axis of the first imaging device 6015 at angle of 45° and reflects specularly into the lens 6020 of the second imaging device 6025 along the second measurement path 6552. The angular margin of the second measurement path 6552 may be comprised within a range defined by the projection onto the second image sensor 6021. In some embodiments, the angular margin may be comprised within 1°, for example 0.5°.

The lighting accessory 6100 or the mobile device 6000 may comprise a controller 6090, for example a digital controller executing a sequence of steps to independently illuminate the one or more LED's.

The LED Ring smallest diameter 6060 would preferably be at least large enough to enable camera's viewfield to image the Color Calibration Card entirely within range of distances 6065 from target, e.g. from 0.5 cm to 10 cm, from 1 cm to 5 cm. The LED Ring diameter at LED optical axis 6060 may be dimensioned, for example, so that the angle between camera's optical axis to the surface to be measured (measurement path 6551, 6552) and line from LED to the surface to be measured (illumination path) is 45°. Multiple rings may also be disposed at different orientations compared to camera optical axis (e.g. 15, 25, 45, 75 and grazing incidence). The LED's may have a fixed aiming towards the 45° or other angle optical axis intercept.

The image sensors and illumination sources, for example comprising one or more LEDs, may be selectively operated to provide multiple measurement paths 6551, 6552, for example using selectively activated illumination paths. One or more illumination sources 6051, 6052, 6053, 6054, 6055, 6057, 6058 may each form one or more collimated light beams, for example a collimated light beam (for example forming a beam angle of less than 15°, for example less than 5°, for example less than 3°) intercepting the optical axis of one or more lenses 6010, 6020 or imaging devices 6015, 6025 at an angle of 45°. For example, referring to FIG. 6A, illumination source 6057 may be spaced from lens 6010 to provide a 45° measurement path when the mobile device is at a target distance from the surface to be measured. For example, an angle of 45° may be formed by tracing a ray from the illumination source's 6057 optical axis to the measurement location 6500 and from the measurement location 6500 to the lens 6010, for example through the lens's 6010 optical axis. The illumination path from the illumination source 6057 to the measurement location 6500 and the measurement path 6551 from the measurement location 6500 to the lens 6010 and image sensor 6011 define a measurement plane. Similarly, illumination source 6058 may be spaced from lens 6020 to provide a measurement path 6551 when the mobile device is at a target distance 6065 from the measurement location 6500 to be measured. The illumination path from the illumination source 6058 to the surface and the measurement path 6551 from the measurement location 6500 to the lens 6010 and image sensor 6011 may also define a measurement plane, which is the same as the plane defined by the path from the illumination source 6057 to the lens 6010 and image sensor 6011. Also in this same measurement plane may be non-45° measurement paths 6552 from illumination source 6057 to the lens 6020 and image sensor 6021, and illumination source 6058 to the lens 6020 and image sensor 6021. The mobile device may be configured to make measurements from both imaging devices simultaneously with illumination from a single illumination source, providing both 45° and non-45° measurements. For example, a measurement acquired under a given illumination, for example 45° illumination provided by illumination source 6057, with the first imaging device 6015 may be equivalent to a measurement made by a colorimeter, and a measurement acquired with the second imaging device 6025 may be equivalent to a measurement made by a glossmeter.

In some embodiments, a user may visualize the images acquired by the one or more imaging devices 6015, 6025, 6035 under illumination from the one or more illumination sources 6057, 6051, 6052, 6053, 6054, 6055, 6058 on the display 6110. The display may provide one or more of numerical, descriptive (using words), or symbolic characteristics of the color, appearance, for example texture or texture parameters, or gloss acquired or measured by the one or more imaging devices 6015, 6025, 6035. In some embodiments, the mobile device may communicate with one or more of a database 6600, for example a remote database, for example comprising a formulation engine, to retrieve information about the acquired target, for example to retrieve formulation information to reproduce the acquired target using paint, paint comprising effect pigments, resin, or ink.

Additional illumination sources may provide additional illumination angles and measurement paths in different measurement planes. For example, illumination source 6051 may be spaced from lens 6010 to provide a 45° measurement path to lens 6010 and image sensor 6011, but the measurement plane for that path would be orthogonal to the measurement plane of illumination source 6057 to lens 6010. Additionally, the measurement path from illumination source 6051 to lens 6020 and image sensor 6021 would provide a non-45° measurement path defining yet another measurement plane which is neither parallel to nor orthogonal to the measurement plane of illumination source 6057 to lens 6010. Once again, the mobile device may be configured to make measurements from both imaging devices simultaneously with illumination from a single illumination source, providing both 45° and non-45° measurements.

Referring to FIG. 6C, illumination source 6251 may be spaced from lenses 6010 and 6020 such that two 45° measurement paths are provided when the mobile device is at a target distance from the measurement location 6500. In this case, the measurement planes defined by the illumination path from illumination source 6251 and measurement path to lens 6010, and the illumination path from illumination source 6251 and measurement path to lens 6020, intersect. These measurement planes may also be orthogonal to each other.

The viewfield of a first imaging assembly 6015 may partly overlap the viewfield of a second imaging assembly 6025. The viewfields of each imaging assembly 6015, 6025, 6035 may overlap with that of one or more other imaging assemblies 6015, 6025, 6035. The controller 6090 may comprise one or more computer processors and one or more non-volatile memory devices 6095. The non-volatile memory device 6095 may comprise computer-readable instructions instructing the processor to i) acquire data from one or more image sensors 6011, 6021, 6031; and ii) derive reflectance information of the surface of interest.

The computer-readable instructions may comprise steps of a method to derive reflectance information of a surface of interest from data acquired from one or more, for example two, image sensors 6011, 6021, 6031 the viewfield of which may overlap with one or more image sensors. The method may selectively instruct one or more illumination sources to illuminate a measurement location 6500 and simultaneously acquire imaging data from two or more image sensors 6011, 6021, 6031. Processing of the imaging data may comprise a comparison with imaging device calibration data. Processing of the imaging data may comprise detecting features of interest in the respective data of the two or more imaging devices 6015, 6025. Processing of the imaging data may comprise matching features of interest, for example computed using a feature detector, for example using a Shi-Tomasi detector, between the data of a first imaging device and a second imaging device. Processing of the imaging data may comprise, using data of features that match between images, for example that correlate above a given threshold, estimating the relative position and orientation, for example using one or more three-dimensional computer vision methods, for example using epipolar geometry, of the first and the second imaging devices with respect to the measurement location 6500. Processing of the imaging data may comprise correcting imaging data, for example color data, using the data of the estimated relative position and orientation.

Acquiring imaging data may comprise imaging coatings, for example coatings comprising effect pigments. Processing imaging data may comprise detecting effect pigment sparkles. Processing imaging data may comprise matching sparkles detected by a first imaging device with sparkles detected by a second imaging device. Processing imaging data may comprise correcting the color of sparkles measured in one or more imaging devices.

Selectively illuminating the measurement location 6500 and simultaneously acquiring imaging data using two or more imaging devices having at least partly overlapping viewfields may provide a method, for example encoded as computer-readable instructions, to: i) measure the color of a portion of the measurement location 6500; ii) measure the sparkle or appearance characteristics of the measurement location 6500; iii) measure the gloss of the measurement location 6500; iv) form a three-dimensional model of the measurement location 6500; and v) form measurements corrected for relative position and orientation of the imaging devices with respect to the measurement location 6500.

FIG. 6D presents a side view of a first embodiment of the lighting accessory for mobile devices 6200 presented in FIG. 6C. In this embodiment, the illumination provided by one or more of illumination sources 6251, 6253, 6057 may be configured so that when the position and orientation of the lighting accessory 6200 is positioned in a measurement position and orientation, for example parallel to the measurement plane 6500 at a distance 6065, the illumination light from one or more sources 6251, 6253, 6057 intercepts the measurement plane at a same measurement location, for example under an illumination of 45° with respect to the measurement plane. The illumination provided by illumination source 6058 may illuminate the measurement location at a shallower angle, for example at an angle within 10° of 63° (atan(2)). Other illumination sources may be positioned further or closer to the first optical device and oriented to illuminate the measurement location, for example with collimated illumination, at a greater or shallower angle atan(3) than that of illumination source 6058.

FIG. 6E presents a side view of a second embodiment of the lighting accessory for mobile devices 6200 presented in FIG. 6C. The second embodiment presents an alternative, or second, configuration for the orientation of the illumination sources 6057, 6058, 6251, 6253. In the second embodiment, the illumination sources aim at a measurement location along a centerline between two or more imaging assemblies 6015, 6025, for example between image sensors 6011, 6021. The illumination sources 6251, 6253 may be configured so that then angle formed between the illumination path and the measurement path is 45°. The measurement path may not be orthogonal to the measurement plane. In this configuration, the image acquired by the image sensors 6011, 6021 of the measurement location may present a geometric symmetry in the region where the viewfields of the imaging assemblies 6015, 6025 overlap.

The lighting accessory may also comprise a mount for the LED Ring comprising, for example, one or more of an adhesive, including adhesive with a foam pad between the LED's and the adhesive; a clamp, similar to clamps used to mount additional lenses onto mobile devices, a shell, a folded back screen cover, or any other suitable mounting structure. Power may be supplied by one or more of: a cable connected to mobile device or its own power storage, comprised e.g. in clamp, shell, or screen cover.

The LED Ring may be triggered to operate by being coupled to communicate with the mobile device via one or more of: a cable connected to mobile device, a wireless interface, for example a Bluetooth wireless interface, or optically via the mobile device's flash. This last option may could be accomplished with a photosensor embedded in the lighting accessory. Lighting accessories including one or more photosensors may also be configured to adjust light intensity, for example based on sensing of ambient light and/or illumination increment contributed by LED's and/or the mobile device's flash. In some embodiments, the LED Rings may also receive commands and/or data from the mobile device via coded or otherwise modulated illumination of flash of the mobile device. The lighting accessory may also comprise a hood to mask partly or totally ambient light.

The lighting accessory may extend to space the mobile device an optimal acquisition distance 6065 from a target surface. In this regard, the lighting accessory may comprise an anti-slip, e.g. rubberized or polymer, surface to contact the target surface, for example to reduce motion during handheld acquisition and avoid causing scratches on the target surface. The lighting accessory may also comprise a Color Calibration Card holder/- or guide to enable sliding-in one or more interchangeable Color Calibration Cards that may be selected depending on the desired measurements camera calibration.

The mobile device in some embodiments is equipped with a stereo camera, for example a camera comprising 2 imaging devices. In these examples, a first color sensor assembly (comprising sensor+lens) 6015 and a second color sensor assembly 6025 are provided. The first and second color assemblies 6015, 6025 may be integral to the mobile device or be comprised in an attachable accessory to the mobile device. The second color assembly 6025 is spaced from first color sensor by a defined distance. For example, the color assemblies may be spaced such that the optical axes of each color sensor are 45° or less apart, or 30° or less apart, 15° apart at optimal acquisition distance. One of the color sensors may have an optical axis that is orthogonal to device's plane, for example to device's display 6110.

The mobile device 6000 with a stereo camera may also include one or more multi-angle illumination assemblies. Each illumination assembly may comprise three or more illumination sources around each imaging device, for example in the X-Y plane, (90° spacing with empty slot or 120° spacing), four illumination sources 6057 around each sensor (90° spacing), or a plurality of illumination sources encircling both color sensors or each sensor.

A user may for example use the mobile device 6000 in a method to acquire conventional photos of objects at a distance greater than the measurement distance 6065, for example using one of the imaging devices 6015, 6025, 6035. A user may for example use the mobile device 6000 in a method to acquire photos that combine images at different exposures or at different focus, for example using two or more of the imaging devices 6015, 6025, 6035. A user may for example use the mobile device 6000 in a method to acquire simultaneous images from different viewpoint, for example using the first imaging device 6015 and the second imaging device 6025, for example to form a three-dimensional image or a three-dimensional model of the acquired scene. Acquisition of images for improved three-dimensional rendering may, for example in a method, be assisted by one or more of sound, voice, or on-display symbols at distances closer to the device than the location where the optical axis of two or more of the imaging devices' optical axis converge. A user may for example use the mobile device 6000 in a method to acquire measurements of color or gloss. A user may for example use the mobile device 6000 in a method to retrieve references, for example paint references, for example paint formulations, from a database 6600, for example a database comprising a formulation engine.

In some embodiments, the mobile device 6000 may be adapted for measuring reflectance properties of a surface of interest 6500, comprising: a first imaging device 6015; a first illumination source 6057 spaced from the first imaging device to provide a first 45° optical path when the mobile device is located at a target distance from the surface of interest, the first 45° optical path comprising a first illumination path and a first measurement path 6551 defining a first measurement plane; a second imaging device 6025 spaced from the first imaging device 6015; a second illumination source 6051, 6052, 6053, 6054, 6058, 6251, 6253 spaced from the first imaging device 6015 and the second imaging device 6025, providing a second optical path when the mobile device is located at the target distance from the surface of interest, the second optical path comprising a second illumination path and a second measurement path 6552 defining a second measurement plane; wherein the first illumination source 6057 is spaced from the second imaging device 6025 to provide a third optical path when the mobile device 6000 is located at the target distance 6065 from the surface of interest 6500, the third optical path comprising a third illumination path and a second measurement path 6552 defining a third measurement plane; wherein the second illumination source is spaced from the first imaging device to provide a fourth optical path when the mobile device is located at the target distance 6065 from the surface of interest, the fourth optical path comprising a fourth illumination path and a first measurement path 6551 defining a fourth measurement plane; wherein the mobile device is configured to process image data acquired from the first and second imaging devices to derive reflectance information of the surface of interest.

In some embodiments, the first, second, third and fourth measurement planes may be in the same plane. In other embodiments, the first and second measurement planes may be parallel to each other, and the third and fourth measurement planes may intersect. In further embodiments, the third and fourth optical paths may comprise one or more 45° measurement paths 6551, 6552 outside of the first measurement plane. In yet further embodiments, the third and fourth optical paths may comprise one or more measurement paths 6551, 6552 forming an angle comprised in a range from 5° to 40° with respect to the illumination path.

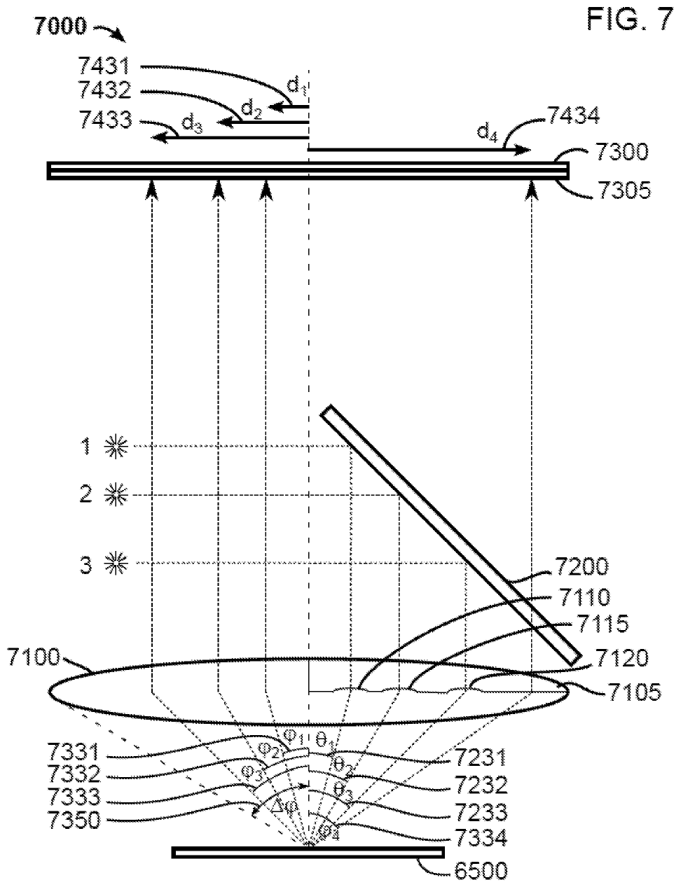

A mobile device for use with the methods and devices disclosed herein may also comprise a camera with Fourier optics. FIG. 7 presents an embodiment of a mobile device with Fourier optics 7000 and illumination assembly. The Fourier optics, via a Fourier lens assembly 7100, convert directional illumination from the illumination assembly into a distance in the camera sensor plane 7300. The Fourier optics assembly 7000 allows simultaneous acquisition of multi-angular data, for example from illumination light reflected from a measurement location 6500.

Fourier optics assembly 7000 comprises collimated illumination sources 1, 2, 3 reflected by a dichroic mirror 7200 reflecting towards a Fourier lens assembly 7100. The Fourier lens assembly's acceptance angle Δφ 7350 may be comprised in a range from 10° to 85°, for example from 20° to 60°, for example from 20° to 50°. The Fourier lens may comprise a mask 7105 comprising apertures 7110, 7115, 7120 for desired angles 7231, 7232, 7233 or θ₁, θ₂, θ₃, e.g. 15°, 45°, possibly 30° or other angles. The Fourier optics assembly may comprise a mask 7305 at sensor plane 7300 with apertures at radial positions 7431, 7432, 7433 represented as d1, d2, d3, corresponding to specular reflection angles 7331, 7332, 7333 represented as φ₁, φ₂, φ₃ from the measurement location 15°, 30°, 45° or other positions. Other positions may comprise aspecular reflection angles for a given illumination angle, for example 45 as 110 represented as 7334 represented as φ₄.

FIG. 9 presents a cross-section of a Color Calibration Card 9000 according to any or all of the examples above may further comprise one or more light sources 9411, 9412, 9421, 9422, 9431, 9432 for illuminating a measurement location 9015 on a surface 9010 to be measured. The light sources may be supported by the card 9100 that may comprise one or more of color patches (not shown), effect pigment patches (not shown), or filters 9200. The light sources, may be white, colored (one or more of red, green, blue—RGB), or a combination of white and colored. The light sources may comprise LED lamps. The light sources may be positioned at one or more of locations around the measurement window of a Color Calibration Card. In one embodiment, the light sources may be equidistant from the measurement location 9015. In another embodiment, the light sources may be arranged on a circular arc or a portion of a spherical dome. In more general embodiments, the light sources may be positioned at one or more distances from the center of the card's measurement window, and may have their optical axis oriented towards the point of measurement at the surface of object to be measured. In some embodiments, the orientations of LED's towards the point of measurement may comprise one or more LED's oriented at 45° with respect to a normal to the surface 9010 to be measured. Embodiments may further comprise other sources of illumination, for example at one or more of 15°, 30°, 75° or 85° from the normal, within a margin of for example 5°. One or more spacers 9310, 9320 to space the light sources from the surface to be measured may be included in the Color Calibration Card.

A controller 9500 may be included and configured to sequentially illuminate the light sources. The light sources may be sequentially illuminated to provide different illumination angles or different colors of illumination. A power source 9600 may also be included.

A structured light source may be embedded in mobile device, provided as plugin device, or be embedded within previously identified devices, and may be used in combination with any of the Color Calibration Cards identified herein. A structured light source in this context projects a known pattern of light (often grids or horizontal bars) on to measurement location. The light patterns appear to deform when striking three-dimensional surfaces, and allow vision systems to calculate the depth and surface information of the measurement location.

Structured light may be projected from a location so that an optical axis of the structured light source intersects with the measurement location at 45° at a focusing distance within camera's short “macro” range, e.g. from 1 cm to 10 cm, for example from 2 cm to 8 cm, for example from 4 cm to 6 cm. Patterns for a structured light source include one or more of parallel rake lines, fan lines, intersecting grid lines. Colors for a structured light source include one or more of white, red, green, or blue. Multiple structured light sources may be provided. For example, a first source for red light, a second source for green light, a third source for blue light. The grid orientations for red, green or blue patterns may be intersecting.

Sources may be illuminated in turn, in pairs, or all together, therefore forming white spots where the grids may intersect if the grids comprise red, green, and blue. Illumination may be supplemented by the mobile devices' white light source, e.g. flash or white LED. Grid illumination may be followed by illumination by the mobile devices' white light source, e.g. flash or white LED.

The methods and devices described herein may be integrated with additional equipment to automate measurements. For example, a robotic arm may be equipped with a color or appearance measurement device, for example a multi-angle spectrophotometer, and, optionally, a lighting system. These components may be fitted to the robot arm's end effector. The robotic arm may then be used to acquire one or more measurements at one or more of the locations of repair or designated locations, for example reference locations designated by the vehicle's manufacturer. The data acquired may be used, for example, to complement a manufacturer's paint modeling database, for example a paint aging database taking into account vehicle and geographic location.

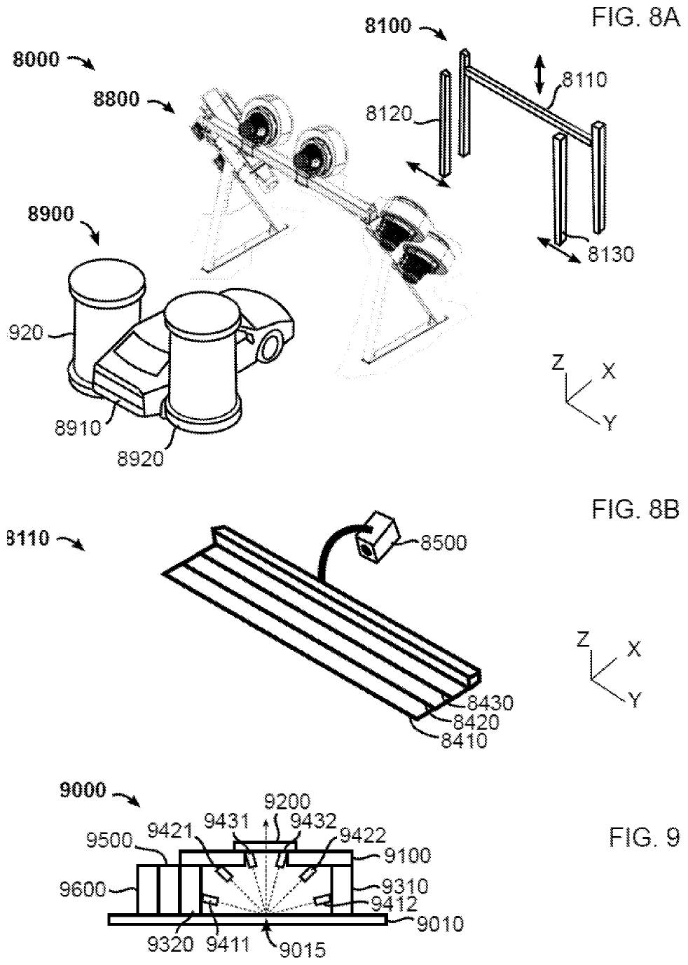

FIG. 8A presents a perspective view of another example: a drive-through arch 8100 that may for example be provided at the exit of an automobile or vehicle wash system 8000 for measuring and/or mapping a vehicle's 8910 paint wear or damage, for example to propose further treatments (polishing, repaint). In this example, the drive-through arch 8100 may comprise an overhead beam 8110, for example a horizontal beam, supporting a plurality of integrated reflectometers for reflectometry. The beam 8110 may move vertically to track vehicle bonnet, roof, and back of an automobile. In the vehicle wash system 8000, the drive-through arch 8100 may for example be made available to the vehicle 8910 after it has passed through washers 8920 and dryer system 8800. Measurements acquired by the drive-through arch 8100 may have greater reliability if the parts to be measured are clean and dry. The drive-through arch 8100 may be located elsewhere, for example at the entrance or exit of a parking infrastructure.

FIG. 8B presents a closer view of an embodiment for a beam 8110 (or a mast 8120, 8130 as described in a subsequent paragraph). The beam 8110 may also support one or more cameras 8500 aimed at the vehicle, for example vertically downwards or at an angle of 45°, and/or one or more rows of light sources 8410, 8420, 8430, e.g. LED's, parallel to the beam. The light sources 8410, 8420, 8430 may form illuminated lines, for example each comprising a single illumination source or a plurality of LED's. The single illumination source and/or LED's may be illuminated in sequence. In some embodiments, the LED's within an illuminated line may be illuminated in sequence. The reflection is acquired by the one or more cameras 8500.

Left and right masts 8120, 8130 for reflectometry may also be provided. The left and right masts may translate laterally (for example along the Y-axis) to match a vehicle's width. The reflectometric measurements may be similar to that of the overhead or horizontal beam 8110.

One or more colorimeters may also be provided, for example, mounted on the horizontal beam, left and/or right masts or robotic arms.

A controller is provided to control motion of the beam, the masts, measurement instruments and illumination sources. The controller may also be connected to sensors and operable to identify a vehicle, e.g. license plate reader, RFID, etc. The controller may also be configured to compute reflectometric measurements, and optionally integrate color measurements, and/or adjust reflectometric measurement based on color measurement. The controller may be configured to associate the measurements with a specific vehicle and store the results in a database.

The controller or other computer system may be configured to compute a proposed maintenance solution and to provide a cost estimate. The controller may also be configured to inform a vehicle owner of results and proposed maintenance solution, for example, via a computer screen, mobile phone notification, or a notice sent to vehicle owner database (e.g. vehicle rental agency).

1. A mobile device (6000) adapted for measuring reflectance properties of a surface of interest (6500), comprising:
a first imaging device (6015) comprising an image sensor (6011) and a lens (6010) characterized by an optical axis;
a first illumination source (6057) having an optical axis intersecting the first imaging device lens' optical axis at an angle of 45°, the optical axes of the first imaging device and the first illumination source defining a first measurement plane;
a second imaging device (6025), spaced from the first imaging device (6015), comprising an image sensor (6021) and a lens (6020) characterized by an optical axis within the first measurement plane;
a second illumination source (6051, 6052, 6053, 6054, 6251, 6253) having an optical axis intersecting the first imaging device lens' optical axis where the first illumination source (6057) intersects the first imaging device (6015) lens' optical axis, the optical axes of the first imaging device (6015) and the second illumination source (6051, 6052, 6053, 6054, 6251, 6253) defining a second measurement plane different from the first measurement plane;
a computer processor (6090);
a non-volatile memory (6095) comprising computer-readable instructions to acquire data from the first and second imaging devices and derive reflectance information of the surface of interest (6500).

2. The mobile device of claim 1, wherein the image sensor (6011) of the first imaging device (6015) and the image sensor (6021) of the second imaging device (6025) have a different resolution.

3. The mobile device of claim 1, wherein the optical axes of the second imaging device (6025) and the second illumination source (6051. 0652, 6053. 6054. 6251, 6253) define a third measurement plane different from the first and second measurement planes.

4. The mobile device of claim 1, wherein the first illumination source further comprises a plurality of illumination sources (6051, 6055, 6058) in the first measurement plane.

5. The mobile device of claim 1, wherein the first and second measurement planes are orthogonal to each other.

6. The mobile device of claim 1, wherein the reflectance information comprises visible color reflectance information.

7. The mobile device of claim 1, wherein the first illumination source's optical axis is disposed at a specular angle with respect to the second imaging device's optical axis.

8. The mobile device of claim 1, wherein the second illumination source's optical axis is disposed at an angle in a range of 15° to 75° with respect to the first imaging device's optical axis.

9. The mobile device of claim 8, wherein the mobile device is configured to acquire image data from the first and second image sensors (6011, 6021) simultaneously.

10. The mobile device of claim 1, wherein a first field of view corresponding to the first imaging device (6015) and a second field of view corresponding to the second imaging device (6025) form an overlapping region (6510), and the mobile device is configured to process image data of the overlapping region to form three-dimensional data of the surface of interest within the overlapping region.

11. The mobile device of claim 1, wherein a first field of view corresponding to the first imaging device (6015) and a second field of view corresponding to the second imaging device (6025) form an overlapping region, and the mobile device is configured to process image data of the overlapping regions to derive surface texture appearance information for the surface of interest.

12. The mobile device of claim 1, wherein a first field of view corresponding to the first imaging device (6015) and a second field of view corresponding to the second imaging device (6025) form an overlapping region, and the mobile device is configured to process image data of the overlapping region to derive effect pigment reflectance information for the surface of interest.

13. The measurement device of claim 1, wherein the first and second illumination sources comprise one or more broadband white light LEDs.

14. The mobile device of claim 1, further comprising a plurality of LEDs located to provide different measurement paths to the first and second imaging devices, the plurality of LEDs selected to emit one or more of red (620-750 nm), green (495-570 nm), blue (450-495 nm), violet (380-450 nm), infrared (700 nm-1 mm), or ultraviolet (10-400 nm) wavelengths.

15. The mobile device of claim 1, wherein the first and second illumination sources (6057, 6051, 6052, 6053, 6054, 6055, 6058, 6251, 6253) are mounted on a lighting accessory (6100, 6200) attached to the measurement device.

16. The mobile device of claim 1, wherein the first and second illumination sources (6057, 6051, 6052, 6053, 6054, 6055, 6058, 6251, 6253) are mounted on a lighting accessory (6100, 6200) attached to the mobile device, and the lighting accessory includes a controller (6090) to illuminate the first and second illumination sources independently of each other.

17. The mobile device of claim 1, wherein the image sensor (6010, 6020, 7300) of at least one of the first and second imaging devices (6015, 6025) is positioned in the imaging device's Fourier transform plane.

18. The mobile device of claim 1, wherein the first and second illumination sources are comprised in a plurality of collimated illumination sources disposed to provide a plurality of illumination angles comprised in a range from 10° to 75° with respect to the optical axis of one or more of the imaging devices.
